(19) United States
(12) Patent Application Publication
(10) Pub. No.: US 2024/0371289 A1
(43) Pub. Date: Nov. 7, 2024

(54) ACTIVE MOBILE EMERGENCY TRAINING SIMULATOR

(71) Applicants: Ido ORLOV, Kibbutz Saad (IL); Hagay ELDAR, Kfar Maymon (IL); Matanya COHEN, Tushiya (IL)

(72) Inventors: Ido ORLOV, Kibbutz Saad (IL); Hagay ELDAR, Kfar Maymon (IL); Matanya COHEN, Tushiya (IL)

(21) Appl. No.: 18/284,321

(22) PCT Filed: Mar. 31, 2022
(86) PCT No.: PCT/IL2022/050344

§ 371 Date: Sep. 27, 2023

Related U.S. Application Data
(60) Provisional application No. 63/169,971, filed on Apr. 2, 2021.

(51) Int. Cl. G09B 9/00; A62C 99/00

(52) U.S. Cl. CPC G09B 9/00; A62C 99/0081

(57) ABSTRACT

A mobile emergency training simulator including a movable simulation structure. The structure includes a plurality of rooms, including a simulator control room; at least one training room; and at least one emergency-simulating or disaster-simulating mechanism configured to simulate at least one of: a natural disaster; a man-made disaster, a medical emergency.

### FIELD OF THE INVENTION

The present invention is in the field of safety and simulations, in particular, a mobile emergency training structure configured to simulate and provide training in emergency situations.

### BACKGROUND OF THE INVENTION

Preparation and training for emergencies such as natural disasters, fires, and medical emergencies can save lives.

Currently, most emergency simulation trainings are conducted in stationary structures, which require dedicated spaces which can be located in isolated and distanced locations.

There is a need in mobile emergency training simulators that can effectively simulate emergencies and allow training of various situations.

### SUMMARY OF THE INVENTION

The present invention relates to an active mobile emergency training simulator configured to reproduce the feelings and challenges of a variety of emergency situations. Such situations may include firefighting (residential, forest fires, buildings, structures, industrial structures); emergency evacuation; terror attacks, car or labor accidents, natural disasters such as earthquake scenarios, wind storms (hurricane, tornado, etc.); hazardous materials; nuclear accident; flooding scenarios, medical emergencies such as heart attack in a significantly realistic manner.

According to one aspect of the present invention, there is provided a mobile emergency training simulator that allows active training of various emergency scenarios.

An aspect of the invention provides a mobile and active emergency training simulator comprising:
a structure comprising:
a plurality of rooms including a simulator control room;
at least one training room; and
at least one emergency-simulating or disaster-simulating mechanism configured to simulate at least one of a natural disaster; a man-made disaster; a medical emergency.

An aspect of the invention provides a mobile and active emergency training simulator comprising:
means to allow the transportation of the simulator, and a structure comprising:
a plurality of training rooms; and
at least one emergency-simulating or disaster-simulating mechanism configured to simulate at least one of a natural disaster; a man-made disaster; a medical emergency.

Another aspect of the invention provides a mobile and active emergency training simulator comprising:
means to allow the transportation of the simulator, and a structure, wherein the structure comprises:
a plurality of rooms including a simulator control room;
at least one training room; and
at least one emergency-simulating or disaster-simulating mechanism configured to simulate at least one of: a natural disaster; a man-made disaster; a medical emergency.

In some embodiments, the simulator includes a scene building module (scene/scenario database module) to simulate or actuate realistic-like environment such as sounds, smell, smoke, tremor; breathing; emergency communications; shaking, heat/cold, wind, rain, dust, and the like.

In one or more embodiments, the at least one emergency or disaster simulating mechanism comprises a platform configured to shake and/or tilt the structure, and/or tilt a room therein, or tilt a cell in the room, to simulate an aspect of an earthquake.

In one or more embodiments, the platform comprises a railing and associated motor to move the room or a portion thereof.

In one or more embodiments, the platform comprises a lifting and/or lowering mechanism to raise or lower at least a portion of, or at least an element of the room, or at last a portion of the structure.

In one or more embodiments, the lifting and/or lowering mechanism comprises one or more stanchions configured to raise or lower at least a portion of, or at least an element of the room, or at last a portion of the structure.

In one or more embodiments, the lifting and/or lowering mechanism comprises a see-saw like device to rock/tilt at least a portion of the room or at least a portion of the structure.

In one or more embodiments, the at least one emergency or disaster simulating mechanism comprises a smoke producing and delivery system, to simulate an aspect of a fire.

In one or more embodiments, the at least one emergency or disaster simulating mechanism comprises a wind generating system, to simulate an aspect of a storm.

In one or more embodiments, the at least one emergency or disaster simulating mechanism comprises a force applying mechanism to allow trapping a subject and simulate the rescue of a trapped subject.

In one or more embodiments, one or more of the rooms includes a heavy item such as a building beam to be lifted or moved.

In one or more embodiments, one or more of the rooms includes a window to allow training an escape of breaking into space for rescue.

In one or more embodiments, one or more of the rooms includes a tunnel to provide for training an escape or breaking into space for rescue.

In one or more embodiments, one or more of the rooms includes a pool of water configured to simulate a lake or similar body of water or a flood situation.

In one or more embodiments, one or more of the rooms includes a lighting adjustment mechanism to simulate a lighting-challenge aspect of an emergency situation.

In one or more embodiments, one or more of the rooms includes a speaker system to simulate noise(s) associated with an emergency situation.

In one or more embodiments, the simulate noise(s) include groaning and/or drying and/or shouting associated with an emergency situation.

In one or more embodiments, the simulator comprising at least one body dummy to simulate an injured or dead body to be evacuated; or moved to safety; or to be medically treated.

In one or more embodiments, the means to allow the transportation of the simulator comprise a motorized vehicle.

In one or more embodiments, the vehicle is selected from a van, a truck, and a car.

In one or more embodiments, the means to allow the transportation of the simulator comprise a vehicle to which the simulator is integrally coupled and a vehicle comprising an attachment mechanism to allow the attachment of the simulator.

In yet a further aspect, the present invention provides a method of simulating an emergency situation or a disaster, the method comprising
providing a mobile and active emergency training simulator as described herein; and
operating the simulator by activating one or more rooms of the simulator to thereby simulate at least one of: a natural disaster; a man-made disaster; and a medical emergency.

In one or more embodiments, operating the simulator is conducted via the control room.

Possible advantages of the present invention include accessibility of the simulator, compact, dynamic, and modular structure that enables illustration of various scenes that can be operated at various locations. Further advantages associated with the herein simulator is that it allows actively simulating and training of various emergency scenarios. The herein invention is therefore suitable to train firefights, medical personnel, urban search and rescue units, specialized army units, and individuals wishing to prepare for emergency situations, and the like.

### BRIEF DESCRIPTION OF THE DRAWINGS

The invention may be more clearly understood upon reading of the following detailed description of non-limiting exemplary embodiments thereof, with reference to the following drawings, in which:

FIG. 1 is a diagram illustrating an exemplary top view of the internal room division of the herein mobile emergency training simulator, according to some embodiments.

FIGS. 2A-2B illustrate the control room of the mobile emergency training simulator, according to some embodiments.

FIGS. 3A-3F illustrate the earthquake simulation room of the mobile emergency training simulator, which includes a floating floor and mechanism configured to allow shaking, according to some embodiments.

FIGS. 4A-4C illustrate the vehicle rescue/extraction room of the mobile emergency training simulator, which includes a vehicle in a distress situation, according to some embodiments.

FIG. 5 is a side view that illustrates a water rescue room with a pool for simulating the rescue of a drowning victim, according to some embodiments.

FIGS. 6A-6C are isometric side views (FIGS. 6A and 6B) and a side view (FIG. 6C) that illustrate a crawl action room of the mobile emergency training simulator, which includes various chambers, according to some embodiments.

FIGS. 7A-7D are an isometric view (FIG. 7A), a front view (FIG. 7B), and side views (FIGS. 7C-7D) that illustrate medical treatment or victim rescue simulation room, which includes a moving cell that is configured to simulate a trapped person, according to some embodiments.

FIGS. 8A-8C are an enlarged view (FIG. 8A), and side views (FIGS. 8B-8C) that illustrate a transverse movement mechanism configured to move a cell back and forth through guide rails, according to some embodiments.

FIGS. 9A-9B illustrate the herein mobile emergency training simulator when placed on top of a hauling truck to allow transportation thereof to various locations; the simulator includes stanchions in a retracted configuration; according to some embodiments.

FIGS. 10A-10C illustrate the herein mobile emergency training simulator when placed on top of a hauling truck and which includes stanchions in an extended configuration, according to some embodiments.

FIGS. 11A-11B illustrate the herein mobile emergency training simulator when placed on the ground and which includes stanchions in a retracted configuration, according to some embodiments.

FIGS. 12A-12D illustrate the herein mobile emergency training simulator when placed on the ground and which includes stanchions in an extended configuration to allow positioning the simulator in an angle, according to some embodiments.

FIGS. 13A-13B illustrate the herein mobile emergency training simulator featuring wheels and a vehicle attachment mechanism, according to some embodiments.

FIGS. 14A-14E illustrate various windows of the herein simulator, according to some embodiments.

FIGS. 15A-15B are a side view (FIG. 15A) and an isometric view (FIG. 15B) that illustrate the herein simulator, which can include two or more structures that can be placed on top of the other, according to some embodiments.

FIGS. 16A-16B are an isometric side view (FIG. 16A) and a side view (FIG. 16B) that illustrate the herein simulator, which can include a flood in an elevator, according to some embodiments.

The following detailed description of embodiments of the invention refers to the accompanying drawings referred to above. Dimensions of components and features shown in the figures are chosen for convenience or clarity of presentation and are not necessarily shown to scale. Wherever possible, the same reference numbers will be used throughout the drawings and the following description to refer to the same and like parts.

### DETAILED DESCRIPTION OF EMBODIMENTS

Illustrative embodiments of the invention are described below. In the interest of clarity, not all features/components of an actual implementation are necessarily described.

The present invention pertains to a mobile emergency training simulator that is configured to actively train staff or individuals to act in emergency situations. The present training simulator is portable and can be transported and situated in various locations without any requirement for special infrastructure or need for significantly large areas. The instant simulator provides for simulation of a variety of emergency situations so as to help train staff or individuals to experience and tackle the challenges associated with emergency scenarios.

As used herein the term ‘simulator’ refers to a device or structure that enables an operator to reproduce or represent under test conditions a phenomenon that is likely to occur in actual performance. The purpose of the herein simulator is for training or experimentation of real-life emergency or disaster phenomenon's.

As used herein the term “active emergency training simulator” refers to the herein simulator which can be activated to simulate at least one emergency or disaster situation.

The herein simulator may include at least two rooms. For example, at least three rooms, at least four rooms, at least five rooms or at least six rooms. The rooms may be disposed adjacent to each other and/or on top of each other.

The herein simulator may include a plurality of rooms, wherein each room may simulate a different scenario. Optionally, the simulator includes a control room that includes means to control the various rooms and different scenarios.

The simulator may be constructed with one or more openings. For example, the simulator may be constructed with one or more windows to allow breaking into the simulator or escape from the simulator. The simulator may be constructed with one or more emergency exit doors. The simulator may be constructed with one or more cameras to visualize the occurrences within the one or more rooms. The simulator may include one or more sensors for sensing smoke, flood, fluid, noise, movement, or any other emergency situation within the simulator.

The simulator affords training in various conditions, such as smoke, fire, noise, rain, flood, wind, shakings, and/or tilts.

The herein simulator further affords exercising various scenarios, such as the rescue of trapped people (e.g., from a tunnel or a car or, from a crushed structure), optionally under harsh conditions, such as wind, rain, and/or earthquake, etc.

The herein simulator is mobile, i.e., the simulator features a vehicle attachment mechanism to allow attaching the simulator to a mobile chassis or vehicle, and/or the simulator is integrally attached to a vehicle. Suitable vehicles include, without limitation, a car, a van, and a truck. Suitable attachement mechanisms may include a cart attachment system having a trailer hitch, including a carrier and a V or a triangular-bracket, pintle hook mount attachment, bumper hitch, pintle hitch and the alike.

Due to the mobility of the herein simulator and associated weight constraints, the simulator may include force applying mechanisms that allow to exert force and simulate the capture of a person or a subject (e.g., a vehicle). Optionally, the force applying mechanism includes a braking mechanism for safety reasons. The force applying mechanism and/or barking mechanism may be controlled remotely from the control room.

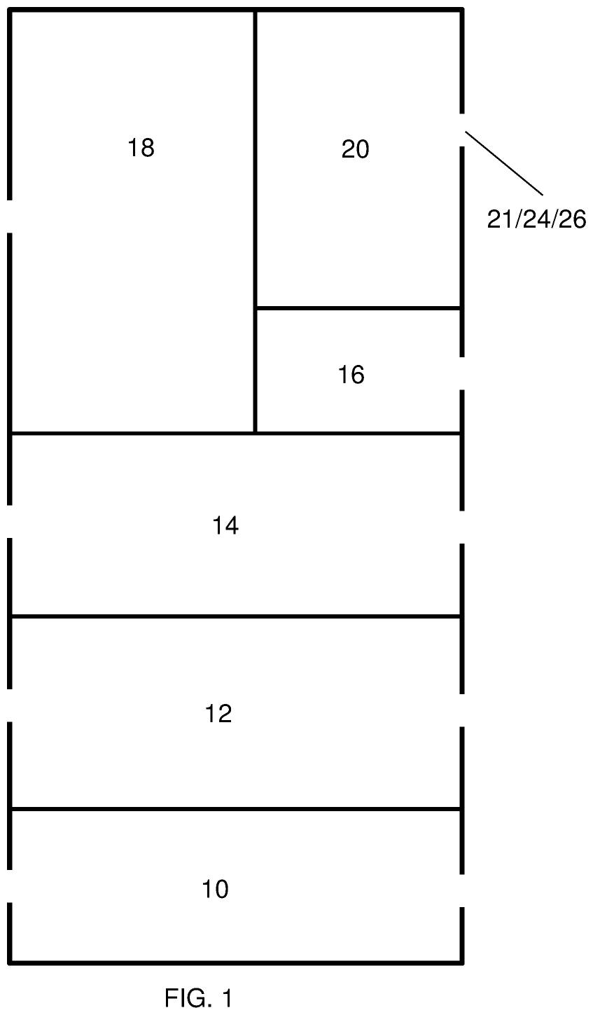

FIG. 1 is a schematic top view that shows a mobile emergency training simulator in accordance with the present invention. The simulator includes a structure having a plurality of rooms or cells such as: a control room 10; an earthquake simulation room 12; a vehicle rescue/extraction room 14; a drowning simulation or water rescue room 16; a crawl action room 18 (which in some embodiments can be actualized in combination with earthquake simulation room 12); and a rescue room 20. The simulator may be constructed with one or more openings, such as windows 24/26 or doors 21. Further additional or alternative rooms may be further contemplated, such as a fire simulation room with smoke, and/or fire, a room that simulates rain, an obstruction simulation room, an accident simulation room, etc.

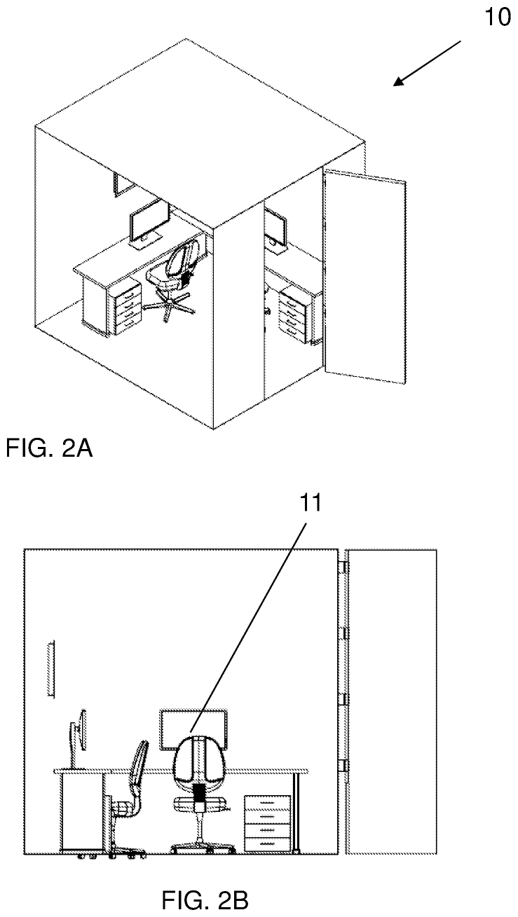

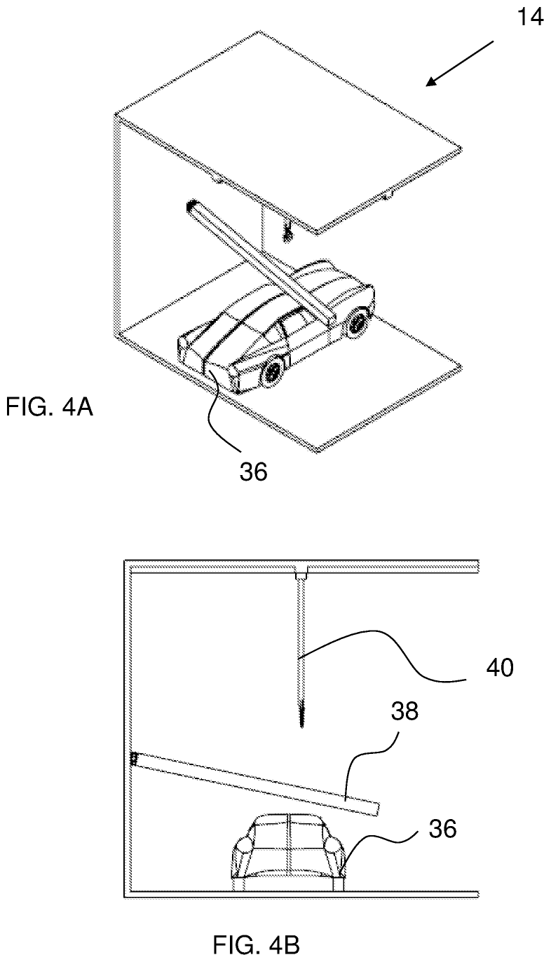

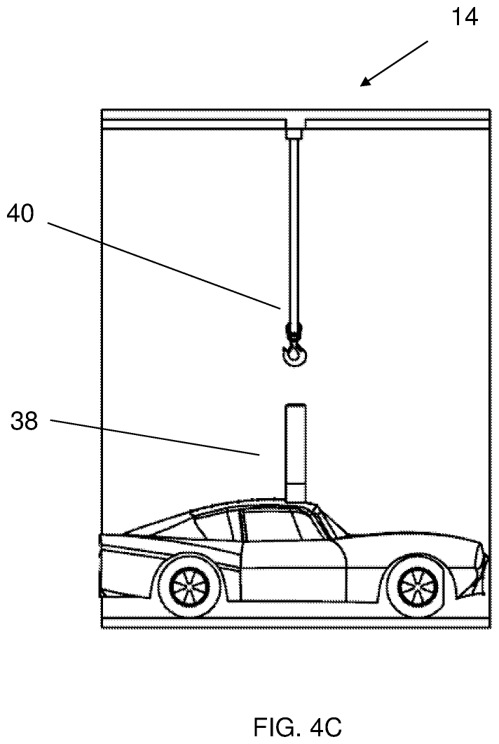

Control room 10 (FIGS. 2A-2B) is configured with equipment (computer and connections, etc.) to control the various emergency scenarios and actions within the rooms. Control room 10 includes at least one screen 11 and computers for monitoring, and/or recording, and/or observing the training sessions within the simulator. Control room 10 includes controllers which may be configured within a PC computer, or any other computerized electronic device for controlling the various effects of the simulator in the various rooms, such as sound, smoke, movement of objects, fire occurrences, earthquake, wind, flooding etc. For example, control room 10 includes means to actuate shaking and/or sliding of earthquake simulation room 12, or movement of cube/cell in medical treatment or victim rescue simulation room 20. For example, control room 10 may include means to monitor a crane-like mechanism 40 in vehicle rescue/extraction and/or escape room 14 (shown in FIG. 4B). By controlling the various effects within the herein simulator and rooms thereof, control room 10 secures the entire training sessions and guarantees the safety of the trainees during trainings. Control room 10 allows communication and sharing information in real time of the various scenarios and trainings within the simulator. The control room 10 further allows recording the training which can be afterwards analyzed and visualized.

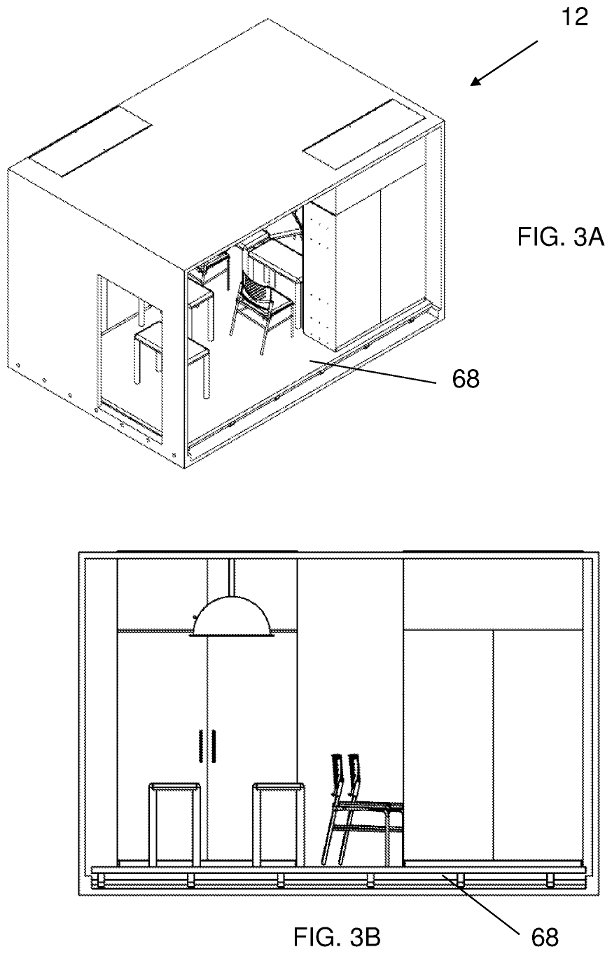

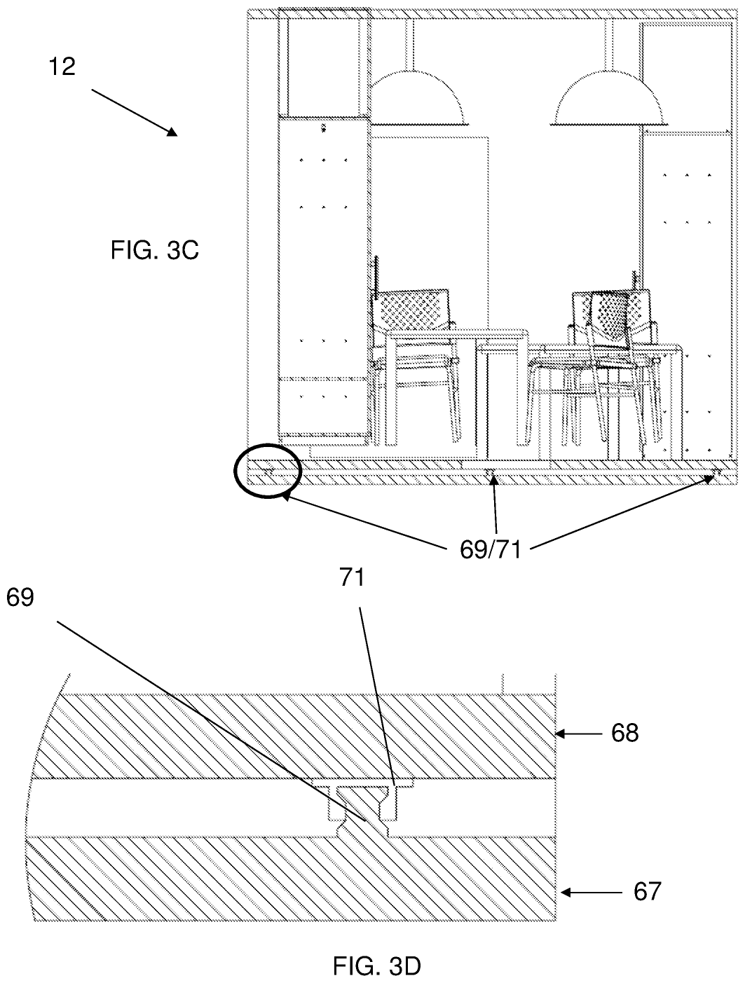

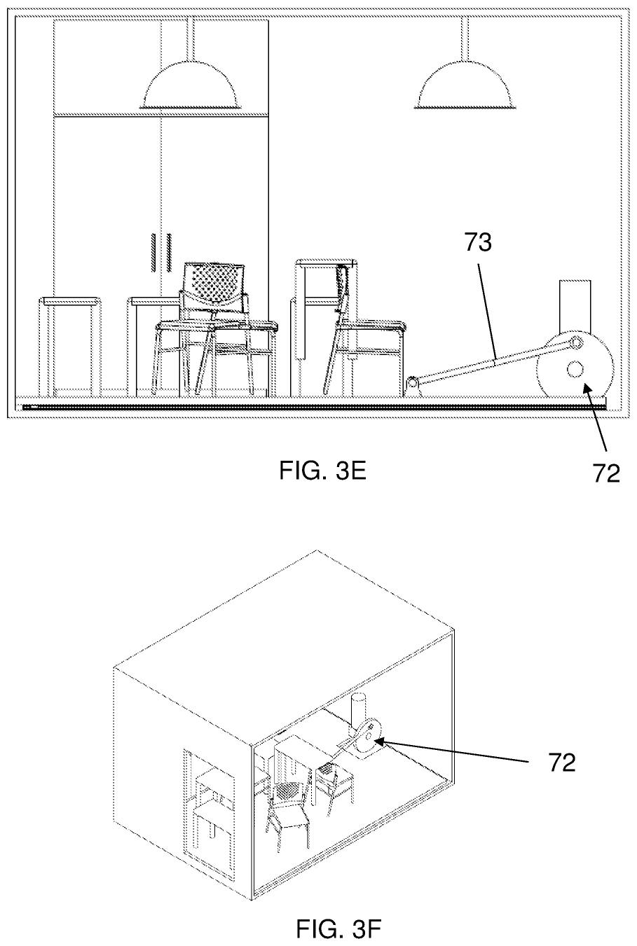

With reference to FIGS. 3A-3F, earthquake simulation room 12 may be constructed with a floating floor 68 to provide increased instability and reality to an earthquake scenario. Earthquake simulation room 12 may be equipped with furniture and is adapted to simulate a situation in which trainees experience an earthquake scenario. The floating floor 68 may be motorized and configured to move in various speeds and/directions. As illustrated in FIGS. 3C-3D, floating floor 68 is disposed above stationary floor 67, and in between floors 67 and 68 there are rail elements 69 and sliding elements 71. A motor 72 (optionally a variator motor that can be concealed within a furniture) is connected to floating floor 68 via connecting arm 73 and, once activated, allows movement of floor 68 (via one or more sliding bearings, ball and socket mechanism, and/or any other sliding or moveable elements, not shown).

FIGS. 4A-4C show vehicle rescue/extraction room 14 with a vehicle 36 in a distress situation, illustrated by a beam 38 having fallen on the vehicle 36. Here, a trainee may be exposed to the action of extracting a victim from the vehicle, and/or being trapped in the vehicle on the way to a rescue mission. FIG. 4C shows beam 38 being controlled by a crane-like mechanism 40 that may be motorized and can be controlled (through control room 10) to lower beam 38 in a chosen location; and/or to swing the beam. Although a car is shown as the vehicle 36, other types of vehicles are contemplated, for example a motorcycle. The room 14 may alternatively or additionally include effects of harsh weather that may include, water flood, or drop, wind, various tilts and the trainee may also exercise alternative scenarios, for example, of changing a wheel in challenging conditions, connecting tubes, etc. As mentioned supra, each of the elements within the various rooms and rescue/extraction room 14, can be controlled by control room 10 remotely such that the trainee(s) within room 14 can instruct the operator of room 10 (without actually seeing the operator in room 10).

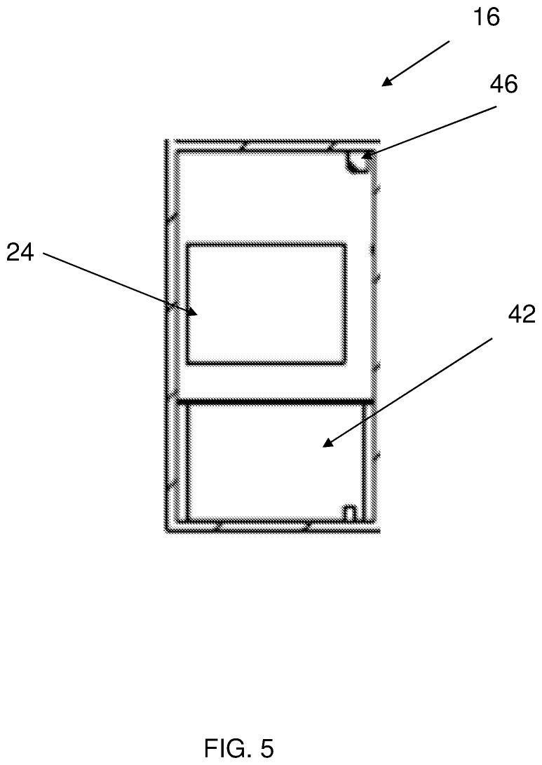

FIG. 5 shows a drowning simulation or water rescue room 16 with a pool 42 that can be used to simulate the rescue of a drowning victim. Pool 42 may be configured to simulate waves. Also illustrated is a camera 46, which may be used to document the rescue and/or for feedback in the control of the scenario/challenge via control room 10. Optionally, room 16 includes one or more drain openings (not shown) to drain any of the water floods or water within pool 42, after or in the course of the simulation. Room 16 may further optionally include one or more windows 24 to allow evacuation from, breaking into the room in case of an emergency or movement to other rooms within the simulator.

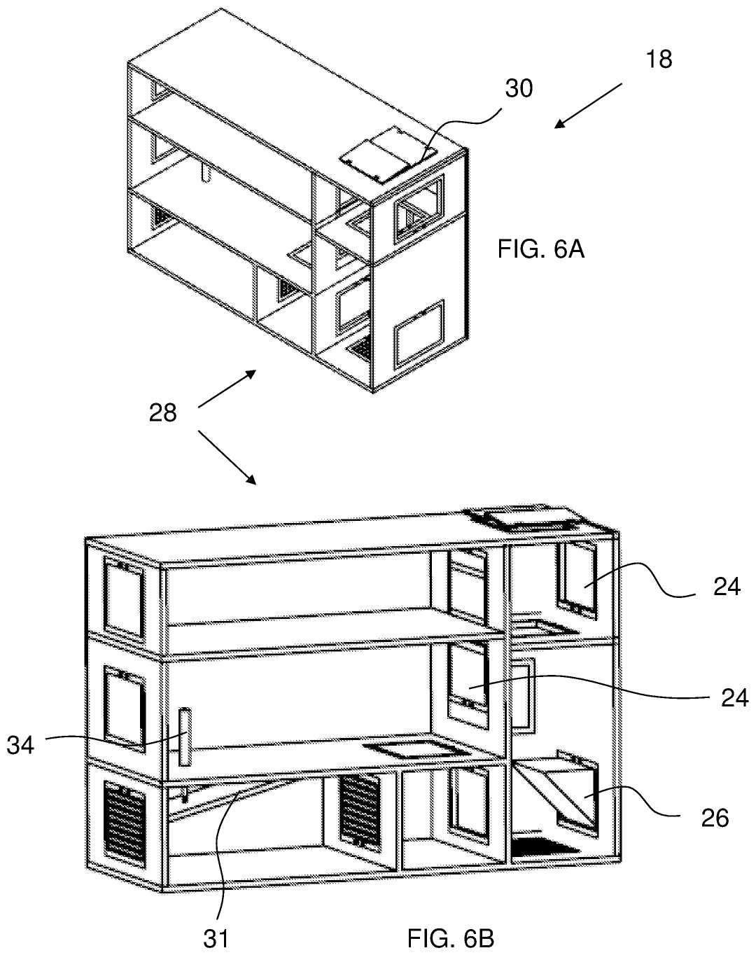

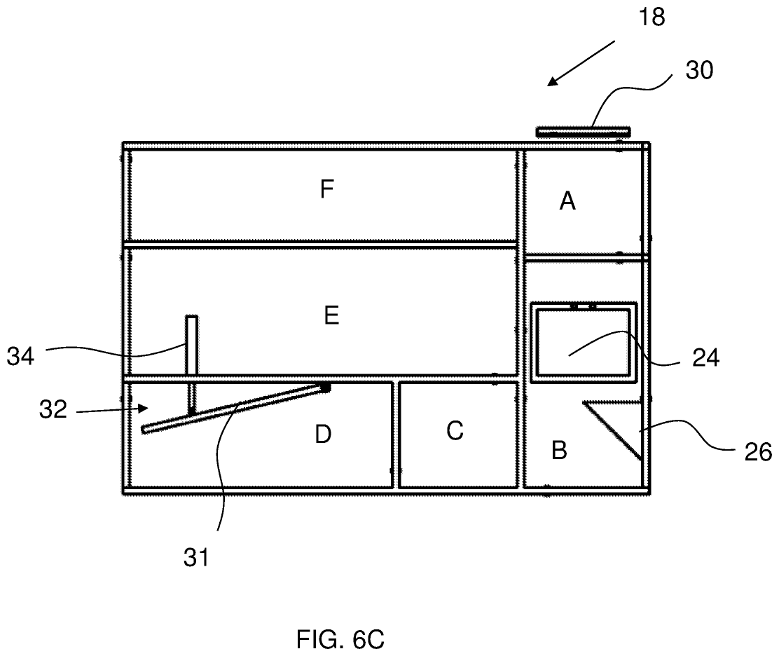

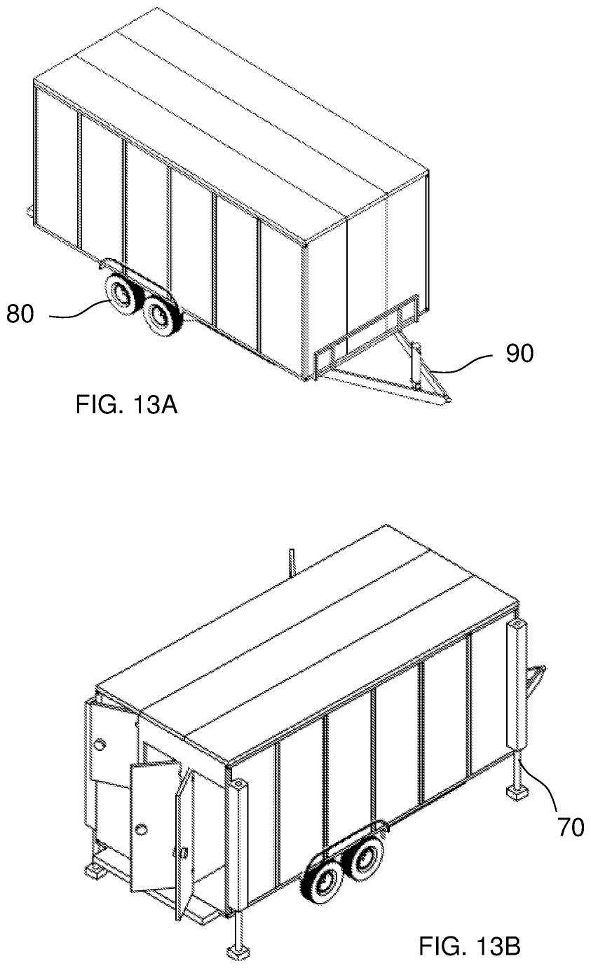

With reference to FIGS. 6A-6C, the mobile emergency training simulator may alternatively or additionally include a crawl action room 18 having multiple chambers A-F (FIG. 6C), wherein, in each chamber, the trainee may exercise a different challenge. For example, chamber E may include wind and/or rain generator system and thus simulate a strong storm, and the trainee may be required to escape from or break into said chamber E through escape window 24 or through angular escape window 26 (shown for example at FIGS. 13A-13E) and while experiencing the storm. Each of the chambers A-F may include one or more of window 24 or angular window 26 (FIGS. 6A-6B). Either/both of window 24 and angular window 26 may have various configurations and at various heights, such as in a multi-story structure 28, and including a roof exit/entrance hatch 30. Window 24 or angular window 26 may be covered by a barrier that requires removal in order to enter therethrough or escape therefrom (see also FIGS. 13A-13E). As also illustrated in FIG. 6C, chamber D may include a collapsing ceiling 32 that may be simulated via a combination of a ceiling 31 and a lowering and/or lifting mechanism, such as piston mechanism 34 (which may be operated or controlled from control room 10), or the like. Piston mechanism 34 may be adapted to exert a force of up to about 1 ton, for example, between about 100 kg and up to about 1000 kg, between about 500 kg and up to about 1000 kg, or between about 100 kg and up to about 500 kg, or above, or below. Chambers A and B are configured to allow rescue using ropes or ladders or the like.

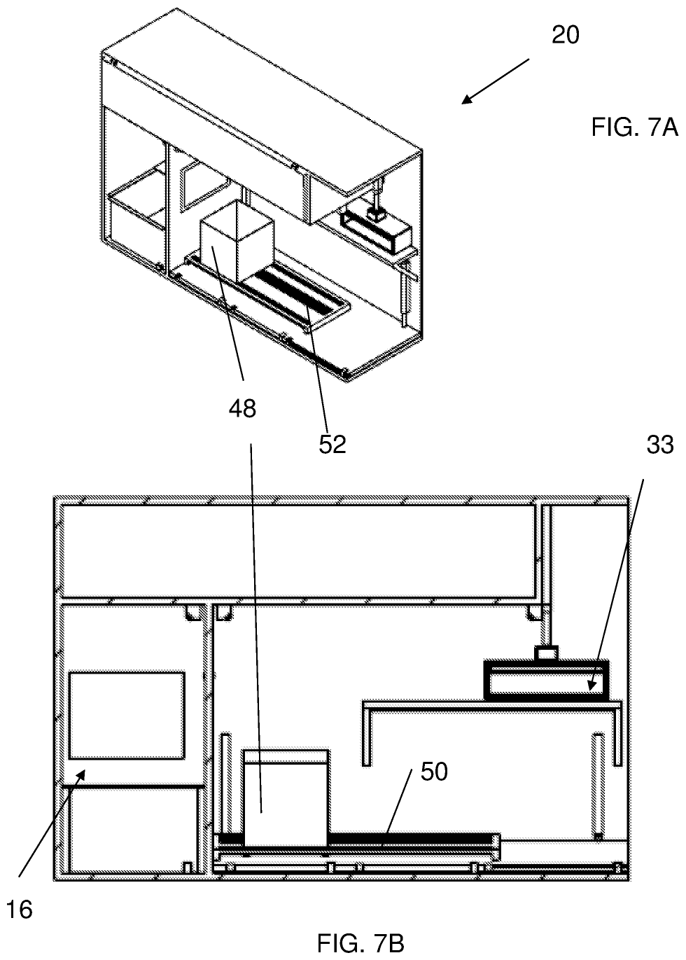

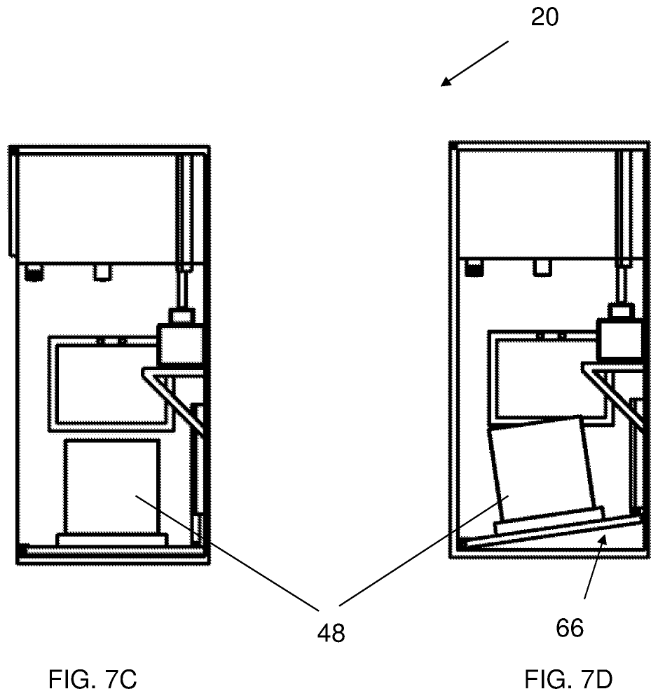

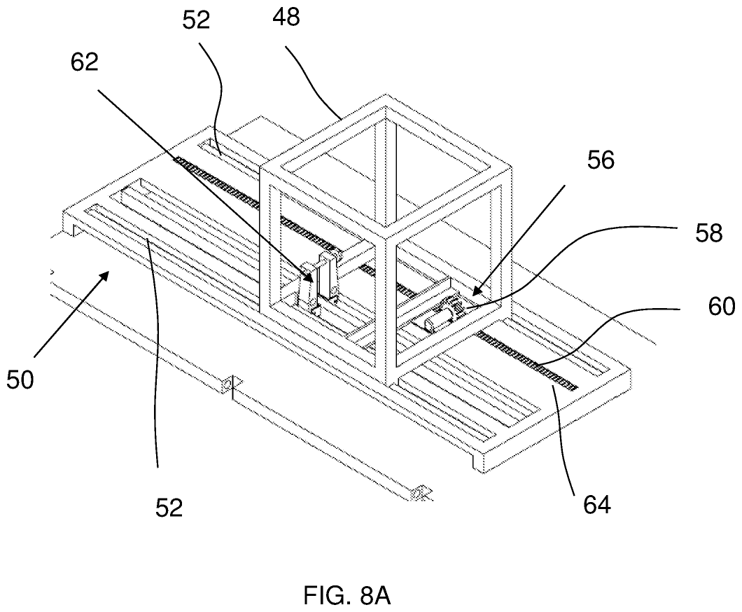

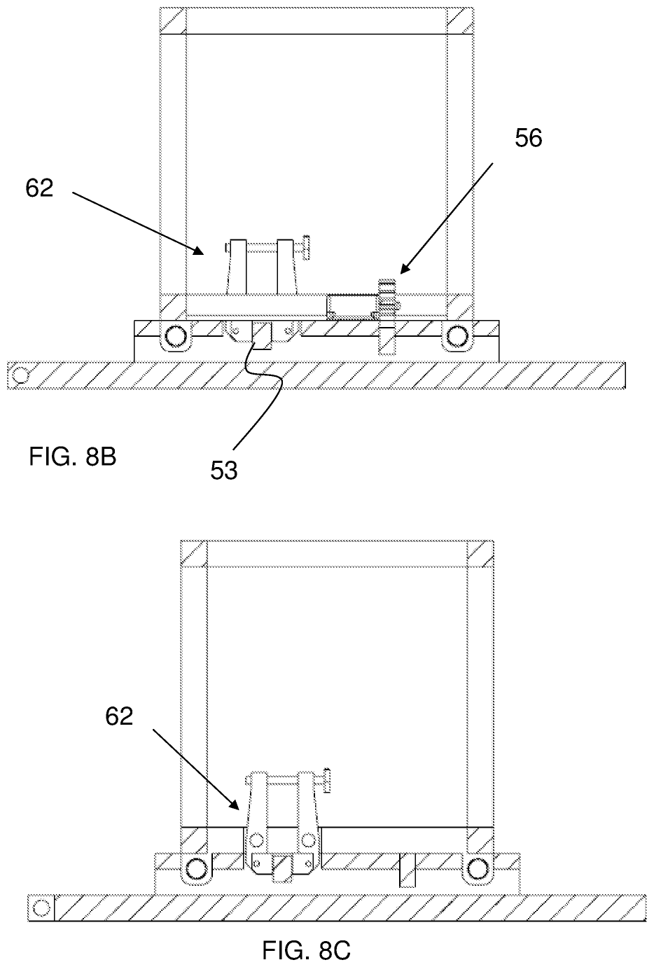

FIGS. 7-8 show various features of medical treatment and/or victim rescue simulation room 20, configured to simulate the rescue of a trapped person. Room 20 may include a trapping box 33 with a force applying mechanism (optionally having a piston) that can exert forces on a victim. Room 20 may include a trapping cell 48 whose movement, force, and orientation are controllable (optionally from control room 10). For example, room 20 may include a transverse movement mechanism 50 configured to move cell 48 back and forth through guide rails 52. Room 20 is configured to allow the rescue of a person/victim that is trapped by cell 48 or box 33 (trapped between elements 48 and/or 33 and a wall).

With reference to FIGS. 7C-7D, cell 48 may also be tiled by a tilt mechanism 66, activated by any means (optionally via control room 10) such as a lever or piston (not shown).

With reference to FIGS. 8A-8C, transverse movement mechanism 50 may include a set of guide rails 52; a rack and pinion system 56 including a motor gear 58 and geared rail 60; and a brake mechanism 62. Some or all of the aforementioned components may be associated with or a portion of a transverse movement mechanism platform 64. As illustrated in FIG. 8B, the brake mechanism 62 includes a stopper 53.

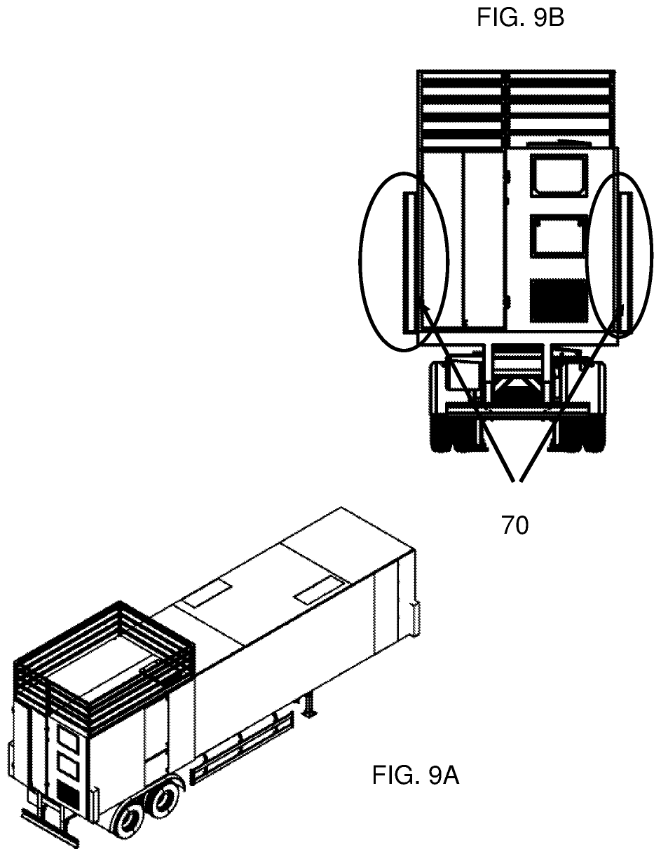

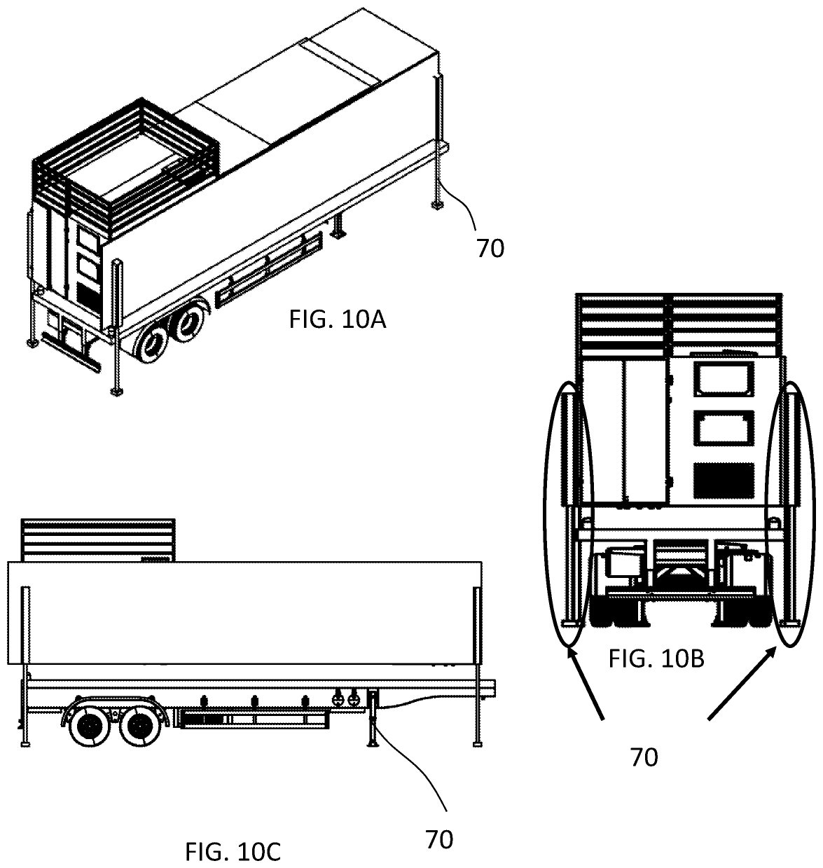

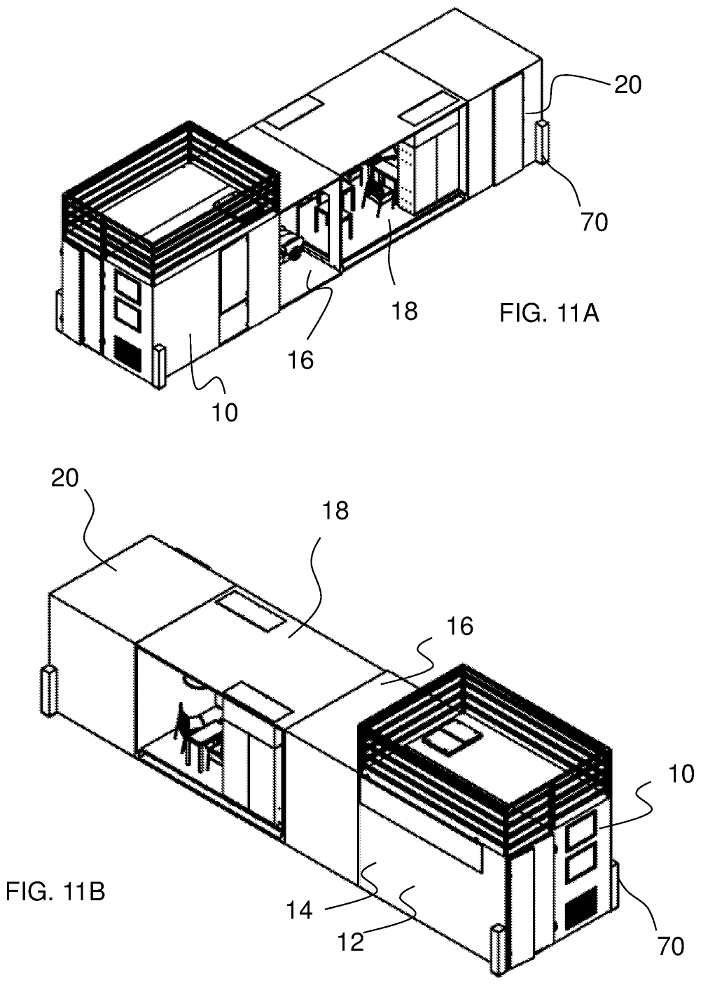

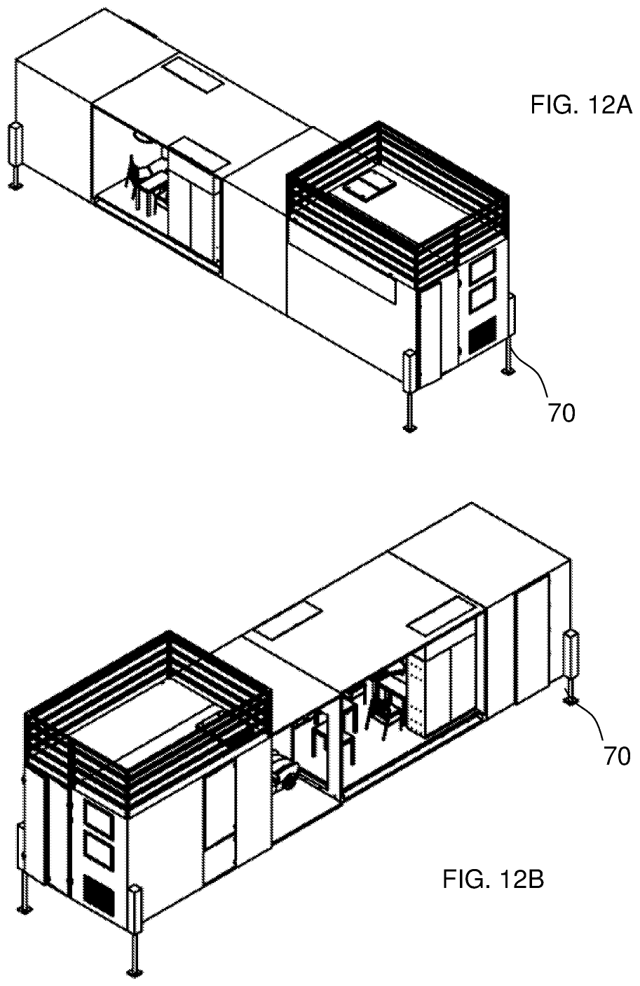

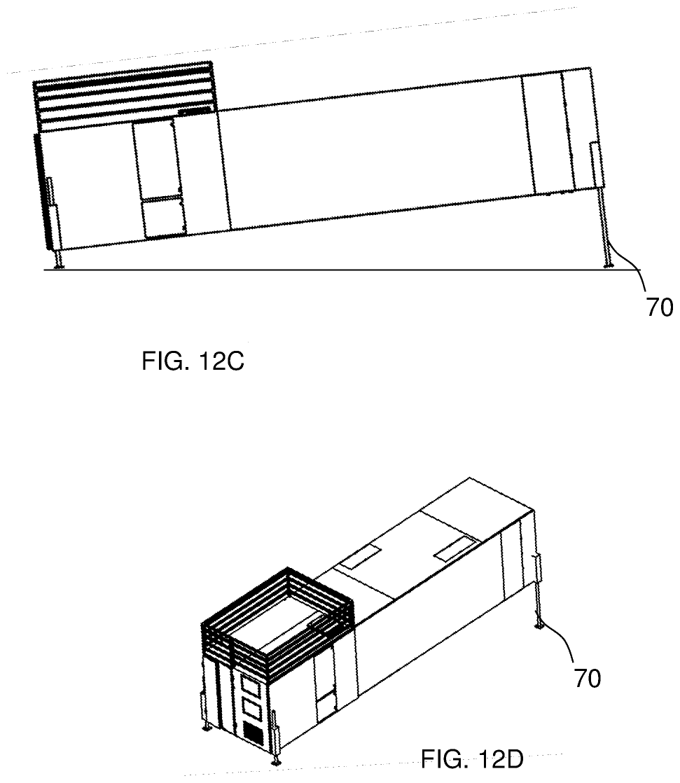

FIGS. 9-12 show the mobile emergency training simulator being carried to and set up at a desired location, which is a particular feature thereof in that the simulator is easily carried and set up in a variety of locations thereby not requiring training personnel to travel to the simulator. FIGS. 9A-9B show the mobile emergency training simulator being hauled to a location such as via a standard flatbed hauling truck. The simulator can be positioned on top of the truck optionally on a platform thereof. The simulator may be placed so that its floor rests directly on the ground (FIGS. 11A-11B), or the simulator may include a set of sturdy stanchions 70 (FIG. 12), for example, generally at the corners of the simulator structure. Stanchions 70 may be long, for example, they may be extended to as long as 2 meters long. Optionally, the simulator is configured such that stanchions 70 are located in a position that extends outwardly from the truck or wheels thereof. In FIG. 9 stanchions 70 are retracted so as not to touch the ground during transport. In FIG. 10 stanchions 70 are extended to allow the truck to easily leave; although alternatively, the simulator may be removed by a fork truck or crane. Optionally, the simulator is integrally manufactured and mounted to a vehicle, such as a truck. The specific configuration of the simulator with stanchions 70 allow unloading from and uploading the simulator with respect to the truck. FIGS. 12A-12D also illustrate that the simulator may be arranged at an angle, which can correspond to the unevenness of the ground, or to intentionally provide an unstable footing to further challenge the trainees.

FIGS. 13A-13B show the mobile emergency training simulator when featuring wheels 80 and a vehicle attachment mechanism 90 that allow to attach and detach the simulator to a vehicle.

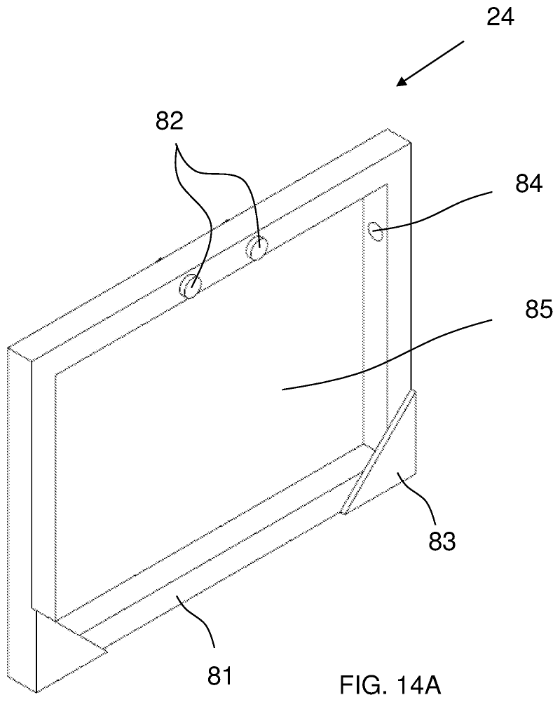

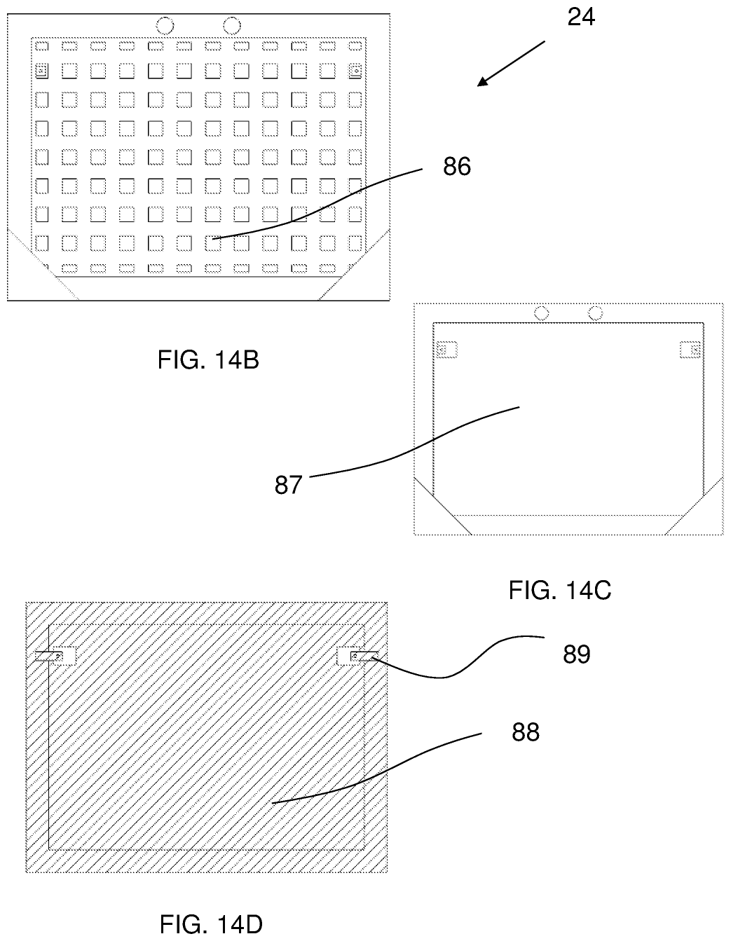

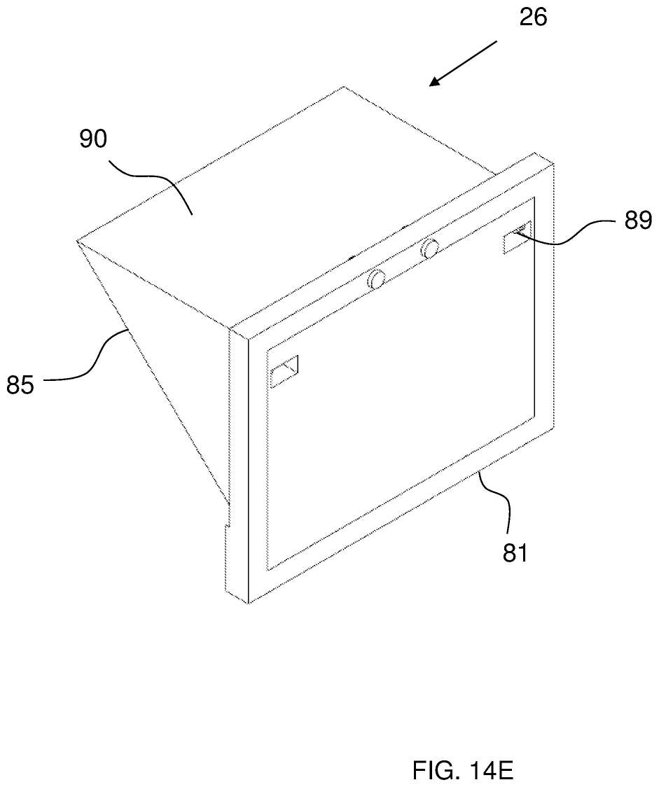

FIGS. 14A-14D illustrate an exemplary window 24 which can be used to allow simulating breaking into the simulator or escaping from the simulator. Window 24 is having a frame 81, one or more illuminating elements 82 which can signal a trainee when and when not to pass through the window 24, and one or more supporting elements 83 for supporting a barrier 85, which without limitation may be a grid 86 (FIG. 14B), a glass 87 (FIG. 14C), a concrete 88 (FIG. 14D), wood, or the like. Window 24 may include one or more slots 84 for securing the barrier 85 with dedicated pins 89. Angular window 26 (shown in FIG. 14E) is similar to window 24 but may alternatively include a barrier 85 disposed angularly to further challenge the trainees.

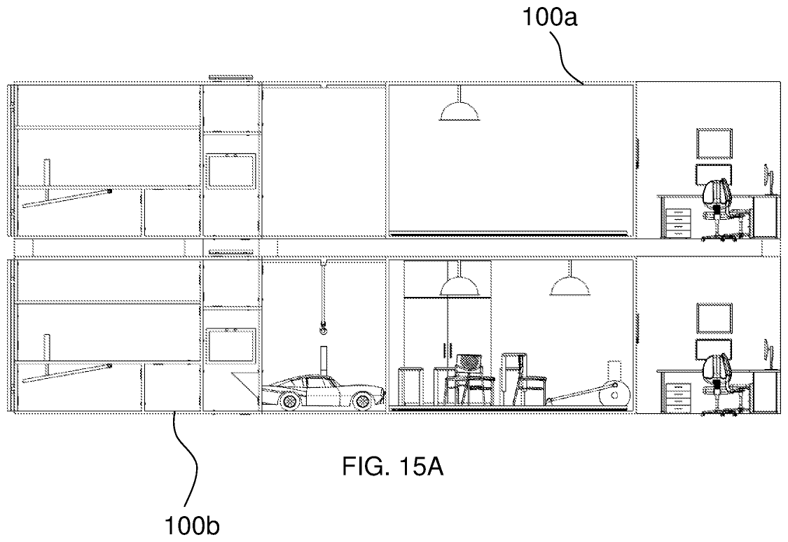

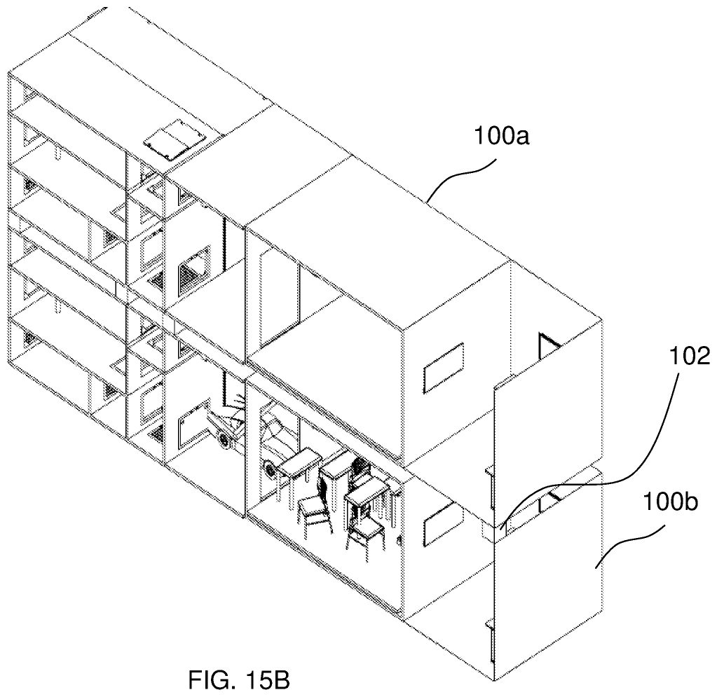

FIGS. 15A-15B illustrate yet another embodiment of the simulator of the invention. The simulator may include a plurality of separated unit structures that can conveniently be attached to each other and also separated from each other. For example, the simulator may include a first and a second structure which can be connected to each other when one is placed on top of the other, as shown in FIGS. 15A-15B. Alternatively, the two structures can be placed one next to the other. Such configurations can enlarge the training space and/or degree of challenge of the scenarios. The connection between structures 100a and 100b may be effected via dedicated connectors 102 having a male and female match and disposed at four corners of the structures 100a and 100b. There may be an opening at the ceiling of structure 100a that allows passage to structure 100b. Alternatively, additionally, when structures 100a and 100b are placed adjacent to each other, an opening may be located on a side wall of one or both structures to allow passage between the structures. Optionally, a space may be kept between the structures when structure 100a includes elements on the roof, that are associated or are part of the trainings.

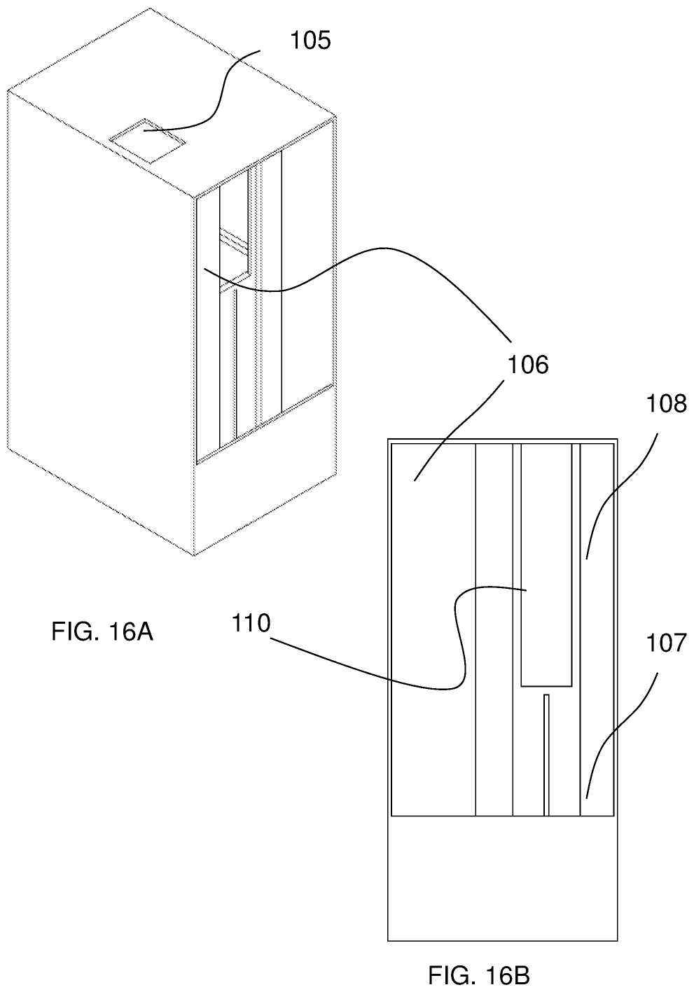

FIGS. 16A-16B Illustrate yet another embodiment of the invention wherein a simulator as herein disclosed, a portion, or a room thereof is placed in a vertical position and simulates an elevator flood scenario. The simulator includes a top opening 105, an elevator side channel 106, at least two floors 107 and 108, and an elevator 110. The simulation includes a scenario in which trainees would be required to open the elevator's door after the elevator got stuck, for example, due to water flood. Here too, as in the other rooms, a control room 10 can control the scenario and elements within a vertical room.

The present invention further provides a method of simulating an emergency situation or a disaster, the method comprises: providing a mobile and active emergency training simulator; and operating the simulator by activating one or more rooms of the simulator to thereby simulate at least one of: a natural disaster; a man-made disaster; and a medical emergency. Optionally, the method comprises transporting the simulator to a desired location which can be a remote location (e.g., located one or more kilometers away from an initial location of the simulator) and require driving the simulator using a vehicle. In one or more embodiments, the method comprises detaching the simulator from the vehicle and placing the simulator in a suitable location. Alternatively, in cases in which the simulator is integrally manufactured or undetachably mounted to a vehicle, the method may comprise parking the vehicle and simulator attached thereto in a suitable and safe location to allow conveniently operating the simulator. Optionally, operating the simulator is conducted via control room 10. Optionally, the method comprises operating the one or more rooms 12, 14, 16, 18, and 20 in the simulator, optionally via control room 10. Optionally, when the training has ended the method comprises attaching the simulator to the vehicle and driving the simulator to a different location.

Although the mobile emergency training simulator has been described with respect to placement on land, mutatis mutandis, the simulator may be configured for use in the water, which may prove useful for emergency simulations for navy personnel, off-shore oil/gas rig personnel, and so on. Alternatively, the herein simulator may be configured for use on the ground only.

As used herein the terms ‘a’ and ‘an’ may mean ‘one’ or ‘more than one’.

All ranges disclosed herein include the endpoints. The use of the term “or” shall be construed to mean “and/or” unless the specific context indicates otherwise.

Each of the following terms: ‘includes’, ‘including’, ‘has’, ‘having’, ‘comprises’, and ‘comprising’, and, their linguistic, as used herein, means ‘including, but not limited to’, and is to be taken as specifying the stated component(s), feature(s), characteristic(s), parameter(s), integer(s), or step(s), and does not preclude addition of one or more additional component(s), feature(s), characteristic(s), parameter(s), integer(s), step(s), or groups thereof. The term ‘consisting essentially of” as used herein means limited to the specified elements and those that do not materially affect the basic and novel characteristic(s) of the claimed invention.

Each of the phrases ‘consisting of’ and ‘consists of’, as used herein, means ‘including and limited to’.

The term ‘method’, as used herein, refers to steps, procedures, manners, means, or/and techniques, for accomplishing a given task including, but not limited to, those steps, procedures, manners, means, or/and techniques, either known to, or readily developed from known steps, procedures, manners, means, or/and techniques, by practitioners in the relevant field(s) of the disclosed invention.

Throughout this disclosure, a numerical value of a parameter, feature, characteristic, object, or dimension, may be stated or described in terms of a numerical range format. Such a numerical range format, as used herein, illustrates implementation of some exemplary embodiments of the invention, and does not inflexibly limit the scope of the exemplary embodiments of the invention. Accordingly, a stated or described numerical range also refers to, and encompasses, all possible sub-ranges and individual numerical values (where a numerical value may be expressed as a whole, integral, or fractional number) within that stated or described numerical range. For example, a stated or described numerical range ‘from 1 to 6’ also refers to, and encompasses, all possible sub-ranges, such as ‘from 1 to 3’, ‘from 1 to 4’, ‘from 1 to 5’, ‘from 2 to 4’, ‘from 2 to 6’, ‘from 3 to 6’, etc., and individual numerical values, such as ‘1’, ‘1.3’, ‘2’, ‘2.8’, ‘3’, ‘3.5’, ‘4’, ‘4.6’, ‘5’, ‘5.2’, and ‘6’, within the stated or described numerical range of ‘from 1 to 6’. This applies regardless of the numerical breadth, extent, or size, of the stated or described numerical range.

Moreover, for stating or describing a numerical range, the phrase ‘in a range of between about a first numerical value and about a second numerical value’, is considered equivalent to, and meaning the same as, the phrase ‘in a range of from about a first numerical value to about a second numerical value’, and, thus, the two equivalently meaning phrases may be used interchangeably.

The term ‘about’, in some embodiments, refers to ±30% of the stated numerical value. In further embodiments, the term refers to ±20% of the stated numerical value. In yet further embodiments, the term refers to ±10% of the stated numerical value.

It should be understood that the above description is merely exemplary and various embodiments of the present invention may be devised, mutatis mutandis, and that the features described in the above-described embodiments, and those not described herein, may be used separately or in any suitable combination; and the invention can be devised in accordance with embodiments not necessarily described above.

1.-22. (canceled)

23. A mobile and active emergency training simulator comprising:
means to allow the transportation of the simulator, and a structure, the structure comprising:
a plurality of rooms including a simulator control room;
at least one training room; and
at least one emergency-simulating or disaster-simulating mechanism configured to simulate at least one of: a natural disaster; a man-made disaster;
a medical emergency.

24. The simulator of claim 23, wherein the at least one emergency or disaster simulating mechanism comprises a platform configured to shake and/or tilt the structure, or tilt a room therein, or tilt a cell in the room, to simulate an aspect of an earthquake.

25. The simulator of claim 24, wherein the platform comprises a railing and associated motor to move the room.

26. The simulator of claim 24, wherein the platform comprises a lifting and/or lowering mechanism to raise or lower at least a portion of the room or at last a portion of the structure.

27. The simulator of claim 26, wherein the lifting and/or lowering mechanism comprises one or more stanchions configured to raise or lower at least a portion of the room or at last a portion of the structure.

28. The simulator of claim 26, wherein the lifting and/or lowering mechanism comprises a see-saw like device to rock/tilt at least a portion of the room or at last a portion of the structure.

29. The simulator of claim 23, wherein the at least one emergency or disaster simulating mechanism comprises a smoke-producing and delivery system, to simulate an aspect of a fire.

30. The simulator of claim 23, wherein the at least one emergency or disaster simulating mechanism comprises a wind generating system, to simulate an aspect of a storm.

31. The simulator of claim 23, wherein the at least one emergency or disaster simulating mechanism comprises a force applying mechanism to allow trapping a subject and simulate the rescue of a trapped subject.

32. The simulator of claim 23, wherein one or more of the rooms includes a heavy item such as a building beam to be lifted or moved.

33. The simulator of claim 23, wherein one or more of the rooms includes a window to provide for escape training therethrough.

34. The simulator of claim 23, wherein one or more of the rooms includes a tunnel to provide for escape training therethrough.

35. The simulator of claim 23, wherein one or more of the rooms includes a pool of water configured to simulate a lake or similar body of water, or a flood situation.

36. The simulator of claim 23, wherein one or more of the rooms includes a lighting adjustment mechanism to simulate a lighting-challenge aspect of an emergency situation.

37. The simulator of claim 23, wherein one or more of the rooms includes a speaker system to simulate noise(s) associated with an emergency situation, wherein the simulate noise(s) include groaning and/or drying and/or shouting associated with an emergency situation.

38. The simulator of claim 23, comprising at least one body dummy to simulate an injured or dead body to be evacuated; or moved to safety; or to be medically treated.

39. The simulator of claim 23, wherein the means to allow the transportation of the simulator comprise a motorized vehicle, the motorized vehice is selected from a van, a truck, and a car.

40. The simulator of claim 23, wherein the means to allow the transportation of the simulator comprise a vehicle to which the simulator is integrally coupled and a vehicle comprising an attachment mechanism to allow the attachment of the simulator.

41. A method of simulating a scenario of an emergency or a disaster, the method comprising
providing a mobile and active emergency training simulator according to claim 1; and
operating the simulator by activating one or more rooms of the simulator to thereby simulate at least one of: a natural disaster; a man-made disaster; and a medical emergency.

42. The method of claim 41, wherein operating the simulator is conducted via the control room.
